(19) United States
(12) Patent Application Publication
(10) Pub. No.: US 2021/0078863 A1
(43) Pub. Date: Mar. 18, 2021

(54) METHOD AND APPARATUS FOR THE EXPANSION OF GRAPHITE

(71) Applicant: FRAUNHOFER-GESELLSCHAFT ZUR FÖRDERUNG DER ANGEWANDTEN FORSCHUNG E.V., Munchen (DE)

(72) Inventor: Sarah Roscher, Freiburg (GM)

(21) Appl. No.: 16/569,264

(22) Filed: Sep. 12, 2019

(51) Int. Cl. C01B 32/19; C01B 32/225; B01J 19/08

(52) U.S. Cl. CPC C01B 32/19; C01B 32/225; B01J 2219/0879; B01J 2219/0803; B01J 19/087

(57) ABSTRACT

In a first implementation, a method for exfoliation of graphene flakes from a graphite sample includes compressing a graphite sample in an electrochemical reactor and applying a voltage between the graphite sample and an electrode in the electrochemical cell.

### BACKGROUND

This disclosure relates to the production of graphene, including an apparatus and a method for the expansion of graphite to graphene.

Graphite is a crystal form of elemental carbon in which sp² hybridized carbon atoms are arranged with each carbon atom surrounded by three other carbon atoms in a plane, at angles of 120°, thus forming a hexagonal lattice in a flat sheet. In naturally occurring graphite, these sheets stack one on top of the other in an ordered sequence, namely, the so-called “AB stacking,” where half of the atoms of each layer lie precisely above or below the center of a hexagonal ring in the immediately adjacent layers. Graphite can have tens to thousands of these layers.

Ideal graphene is a one-layer thick sheet of graphite, infinitely large and free from impurities. However, real world graphene tends to occur in small flakes which are multiple layers thick. These flakes often contain impurities such as oxygen atoms, hydrogen atoms, or carbon other than sp² hybridized carbon. Notwithstanding these imperfections, real world graphene has a number of unusual physical properties, including very high elastic modulus-to-weight ratios, high thermal and electrical conductivity, and a large and nonlinear diamagnetism. Because of these unusual physical properties, graphene can be used in a variety of different applications, including transparent, conductive films, electrodes for energy storage devices, or as conductive inks.

Although ideal graphene is one-atom thick, sheets of graphene with multiple layers (e.g., up to 10 layers) can provide comparable physical properties and can be used effectively in many of these same applications. Accordingly, “graphene” as described in this application may contain multiple layers.

Due to its useful properties, graphene production is an important industrial endeavor. One method of producing graphene is by electrochemical expansion of graphite.

Some electrochemical methods of graphene production utilize anodic exfoliation. Anodic exfoliation tends to oxidize graphene, thus introducing defects. In contrast, cathodic exfoliation yields graphene flakes without oxidation defects. However, cathodic exfoliation typically requires sonication, which results in small flake size. Cathodic exfoliation also requires a suitable graphite starting material. For example, highly oriented pyrolytic graphite (HOPG) is suitable for cathodic exfoliation, but HOPG can be costly.

Furthermore, cathodic exfoliation can occur at different layers distributed throughout different parts of the graphite, rather than layer-by-layer, starting from a surface. During cathodic exfoliation, large pieces of graphite can break away from the cathode. Once a piece breaks away from the cathode, electrical contact with the cathode is lost, and exfoliation within that piece stops.

This disclosure relates to the production of graphene, including an apparatus and a method for the expansion of graphite to graphene.

### SUMMARY

An apparatus and a method for expansion of graphite to graphene, are described herein.

In a first aspect, a method for exfoliation of graphene flakes from a graphite sample includes compressing a graphite sample in an electrochemical reactor and applying a voltage between the graphite sample and an electrode in the electrochemical cell.

In a second aspect, combinable with any other aspect, the method includes pressing the graphite against an electrode member using a moveable ceramic membrane, wherein the ceramic membrane is permeable to the electrolyte.

In a third aspect, combinable with any other aspect, the method includes annealing hydrogenated graphene flakes at 500 to 800° C. to yield graphene flakes.

In a fourth aspect, combinable with any other aspect, the electrode member is a cathode.

In a fifth aspect, combinable with any other aspect, the graphite sample is in electrical contact with a boron-doped diamond cathode member.

In a sixth aspect, combinable with any other aspect, the electrolyte includes propylene carbonate and 0.1 M tetrabutylammonium hexafluorophosphate.

In a seventh aspect, combinable with any other aspect, the applied voltage is −5 V to −100 V.

In an eighth aspect, combinable with any other aspect, the method includes varying a force that compresses the graphite sample.

In a ninth aspect, combinable with any other aspect, varying the force includes reducing a pressure pressing the graphite sample against the cathode member after 2-3 hours of applied voltage at −60 V.

In a tenth aspect, combinable with any other aspect, the method further includes pelletizing the graphite sample.

In an eleventh aspect, combinable with any other aspect, the method further includes applying the voltage for a total of 24 hours.

In a twelfth aspect, combinable with any other aspect, an apparatus for the exfoliation of graphite includes an electrochemical reactor, electrodes including an anode and a cathode member, a graphite sample, and a compression apparatus configured to compress the graphite sample during an exfoliation reaction.

In a thirteenth aspect, combinable with any other aspect, the compression apparatus is configured to press the graphite sample against an electrode.

In a fourteenth aspect, combinable with any other aspect, the electrode is the cathode member.

In a fifteenth aspect, combinable with any other aspect, the graphite sample is free from binder.

In a sixteenth aspect, combinable with any other aspect, the apparatus further includes at least two anodes.

In a seventeenth aspect, combinable with any other aspect, the cathode member further includes boron-doped diamond.

In an eighteenth aspect, combinable with any other aspect, the cathode member further includes a metal film.

In a nineteenth aspect, combinable with any other aspect, the apparatus further includes an electrolyte solution.

In a twentieth aspect, combinable with any other aspect, the electrolyte solution includes anhydrous propylene carbonate.

In a twenty-first aspect, combinable with any other aspect, the electrolyte solution further includes 0.1 M tetrabutylammonium hexafluorophosphate.

In a twenty-second aspect, combinable with any other aspect, the compression apparatus includes a ceramic membrane.

In a twenty-third aspect, combinable with any other aspect, the ceramic membrane is disposed in a membrane press, and the membrane press includes one or more rods and one or more force application mechanisms configured to apply force to the rods.

The details of one or more implementations are set forth in the accompanying drawings and the description below. Other features, objects, and advantages will be apparent from the description and drawings, and from the claims.

### DESCRIPTION OF DRAWINGS

FIG. 1 is a schematic representation of an apparatus for the expansion of graphite.

FIG. 2 is a flowchart illustrating an example method of expanding graphite.

FIG. 3 is an example X-ray diffraction spectrum of graphite and exfoliated graphite.

FIG. 4A is an example Raman spectrum of graphite before and after exfoliation in the range of 1400 to 2800 cm⁻.

FIG. 4B is an example Raman spectrum of graphite before and after exfoliation in the range of 2200-3200 cm⁻.

FIG. 5 is an example infrared (IR) spectrum of exfoliated graphite in the range of 4000-500 cm⁻.

FIG. 6 is an example Raman spectrum of hydrogenated graphene before and after annealing.

FIG. 7 is an example atomic force microscopy image of hydrogenated graphene flakes.

FIG. 8 is an example size evaluation of over 600 graphene flakes using optical microscope images.

FIG. 9 is an example of the electrical resistance of graphene flakes as a function of transparency, determined using the Van der Pauw method.

### DETAILED DESCRIPTION

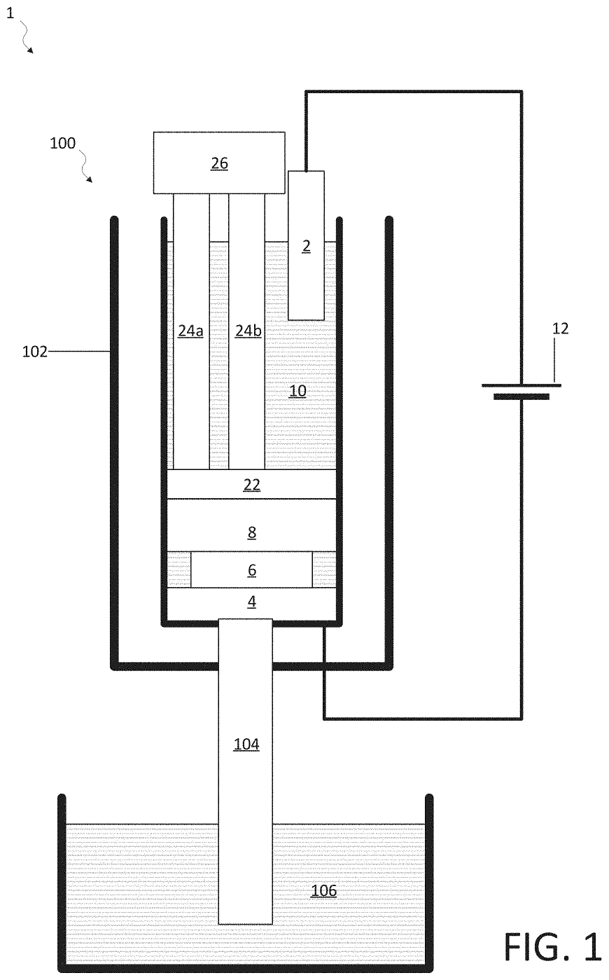

FIG. 1 shows an apparatus 1 that can be used to produce graphene using the methods described herein. The apparatus 1 includes an electrochemical chamber 100 and electrodes. The electrodes include at least one cathode 4 and at least one anode 2. The apparatus further includes an electrolyte 10 and a voltage or current source 12. The apparatus includes a graphite pellet 6. The graphite pellet is in electrical contact with the cathode 4. The apparatus also includes a permeable ceramic membrane 8. In some implementations, the ceramic membrane 8 is held in a membrane press 22. In some implementations, one or more rods 24 are attached to the membrane press, and counterweights 26 can be placed on the rods 24. The apparatus may include a heat sink 104.

The electrochemical chamber 100 is bounded by chamber wall 102. The electrochemical chamber 100 is large enough to house at least the electrodes, electrolyte, and graphite pellet. The electrochemical chamber 100 can have a round base and a generally cylindrical shape. The chamber wall 102 can comprise polytetrafluoroethylene.

The cathode 4 may be disposed in the electrochemical chamber 100. In some implementations, the cathode 4 either forms the bottom surface or substantially fills the entire bottom surface of the chamber 100. In some implementations, the cathode contains, for example, a metal, an alloy, or porous silicon. In some implementations, the cathode can be a silicon wafer, for example, a prime grade silicon wafer. The wafer can be any size suitable to be housed inside the electrochemical chamber 100. For example, the wafer can be 4 inches (10.16 cm) in diameter, 300-400 μm thick, and have a resistivity of 0.01-0.02 ohm×cm. In some implementations, the cathode 4 may also include or be formed of diamond. For example, the cathode can include a diamond layer on the surface that faces the electrolyte. For example, a silicon wafer can be overgrown with boron-doped diamond (BDD) by seeding the wafer with 4 nm hydrogen-terminated nanodiamonds followed by diamond growth in a microwave plasma chemical vapor deposition reactor to yield a cathode with a diamond film. The thickness of the diamond film may be about 300 nm to about 20 μm or from about 2 μm to about 5 μm. The diamond layer of the cathode 4 may optionally be doped using an n- or p-type dopant. Such doping may reduce the electric resistance of the cathode. In some implementations, boron may be used as a dopant. The concentration of boron may be about 10²¹ atoms/cm³. In some implementations, the underside of the cathode 4, i.e., the side of the cathode facing the bottom of the chamber 100, can be coated with a metal film 44, for example a titanium-gold film. Coating the underside of the cathode 4 with a metal film 44 can produce a more uniform current distribution during operation of the apparatus.

The anode 2 can be disposed in chamber 100. The anode can contain, for example, a metal, an alloy, or porous silicon. In some implementations, the anode can be a silicon wafer, for example, a prime grade silicon wafer. The wafer can be any size suitable to be housed inside the electrochemical chamber 100. For example, the wafer can be a wafer 4 inches (10.16 cm) in diameter, 300-400 μm thick, and have a resistivity of 0.01-0.02 ohm×cm. In some implementations, the anode 2 may also include or be formed of diamond. For example, the anode can include a diamond layer on the surface that faces the electrolyte. For example, a silicon wafer can be overgrown with boron-doped diamond (BDD) by seeding the wafer with 4 nm hydrogen-terminated nanodiamonds followed by diamond growth in a microwave plasma chemical vapor deposition reactor to yield an anode with a diamond film. The thickness of the diamond film may be about 0.5 μm to about 20 μm or from about 2 μm to about 5 μm. The diamond layer of the anode 2 may optionally be doped using an n- or p-type dopant. Such doping may reduce the electric resistance of the anode. In some implementations, boron may be used as a dopant. The concentration of boron may be about 10²¹ atoms/cm³.

The anode may be disposed at any angle relative to the cathode. In some implementations, the anode may be disposed horizontally in the chamber, for example, such that the surface of the anode is parallel to the surface of a generally planar cathode that is also disposed horizontally. Alternatively, the anode may be disposed vertically in the chamber, such that the surface of the anode is perpendicular to the surface of such a cathode. One advantage of disposing the anode at an angle relative to the cathode is that it prevents even build-up of reaction byproducts on the anode. In particular, when the apparatus is in operation, decomposition of the electrolyte can result in the buildup of a polymer or byproduct at the anode. When the anode is disposed at an angle, for example, 90 degrees relative to the cathode, the aggregation of the byproduct polymer on the anode is concentrated at locations closest to the cathode. This is believed to be due to the current distribution along the anode. Disposing the anode at an angle also prevents the buildup of gas bubbles along the anode, as gas bubbles may be produced during operation of the apparatus.

In some implementations, more than one anode may be disposed in the chamber. For example, two anodes may be disposed in the chamber, both angled relative to the cathode.

The apparatus includes at least one electrolyte disposed in the chamber 100 between the anode 2 and the cathode 4. In some implementations, the electrolyte may be an aqueous electrolyte, and may optionally contain substances to increase its electrical conductivity, such as, for example, dilute acids or salts. In other implementations, the electrolyte can include or be formed of at least one organic solvent. In still other implementations, the electrolyte can include anhydrous propylene carbonate and/or dimethylformamide and/or organic salts, whose ions inhibit the formation of a stable crystal lattice through charge delocalization and steric effects so that they are liquid at temperatures below 100° C. In some implementations, the electrolyte can include 0.1 M tetrabutylammonium hexafluorophosphate (TBA PF₆) and anhydrous propylene carbonate (PC).

The apparatus also includes a voltage source 12 that can apply an electric voltage between the electrodes. In some implementations, an electrical voltage of between approximately 5 V and approximately 100 V, or between approximately 30 V and approximately 60 V, is applied between the electrodes by the electric voltage source 12. In some implementations, the electrolyte contains anhydrous propylene carbonate, which can be decomposed by the electric field to yield propene and carbonate gas. Propylene carbonate can intercalate between graphite layers, driven by the electric voltage. The propylene carbonate may decompose there to propene and carbonate gas. The gasses can overcome the Van der Waals attraction between layers of the graphite pellet and exfoliate the graphite into graphene sheets. In addition, the electrolyte can include tetrabutylammonium hexafluorophosphate (TBA PF₆), for example, 0.1 M TBA PF₆. The TBA cation can intercalate between graphite layers. The large steric size of the TBA cation contributes to the exfoliation of graphite. Co-intercalation with propylene carbonate and TBA is possible. During operation of the apparatus, fresh electrolyte can be added to drive further exfoliation.

In addition to the intercalation of, e.g., propylene carbonate and TBA cations, the applied voltage produces hydrogen at the cathode. Hydrogen produced at the cathode can also react with the planes of graphite, for example, by chemisorption. Accordingly, the graphite at the cathode can become hydrogenated.

In some implementations, the graphite to be expanded is a pressed pellet 6. For example, the pressed pellet can be created by pressing powdered graphite with sufficient pressure to create a solid pellet. A binder is not needed to create the pellet. For example, a pressure of 13000 to 19000 Newtons/cm² can result in a solid graphite pellet, without the need for a binder. The graphite pellet 6 is placed in the apparatus so that it is in electrical contact with the cathode.

The apparatus also includes a moveable, ceramic membrane 8. The ceramic membrane 8 is permeable to the electrolyte. The permeable ceramic membrane can be disposed to press the graphite pellet 6 against the cathode 4 and maintain the graphite pellet in contact with the cathode. Thus, the electrolyte can flow freely through the membrane while the graphite pellet 6 is maintained in electrical contact with the cathode 4.

In some implementations, the ceramic membrane can be larger than the graphite pellet. For example, the ceramic membrane can be 60-80% larger than the pellet. The ceramic membrane can be parallel or substantially parallel to the cathode and/or the bottom of the chamber 100. The ceramic membrane can fill or substantially fill the cross-sectional area parallel to the cathode and/or the bottom of the chamber 100.

In some implementations, the ceramic membrane can be disposed in a membrane press. For example, the permeable ceramic membrane can be disposed in the center of a ring to form the membrane press. The ring can comprise polytetrafluoroethylene. In some implementations, the membrane press is weighted in order that the ceramic membrane presses against the graphite pellet and maintains the graphite pellet in electrical contact with the cathode. In some implementations, the weight is provided by rods 24 attached to the ring, with one or more counterweights 26 on top of the rods 24. The rods 24 may comprise polyether ether ketone (PEEK). The counterweights can have a total combined weight sufficient to press the ceramic membrane against the graphite pellet and maintain the graphite pellet in electrical contact with the cathode. For example, the total combined weight of the one or more counterweights can provide a downward pressure between 0.003 and 0.3 Newtons/cm².

In some implementations, the apparatus includes a heat sink 104. The illustrated heat sink includes a thermally conductive rod in contact with the cathode 4 at one end and a coolant 106 at the other end. In some implementations, the coolant 106 is a water bath. The heat sink can either heat or cool the apparatus. High temperatures can boil the electrolyte, which hinders the cathodic exfoliation. Conversely, low temperatures decrease the conductivity of the electrolyte. Therefore, the heat sink can be used to maintain the electrolyte at an ideal temperature. For example, a suitable temperature range can between 20-80° C.

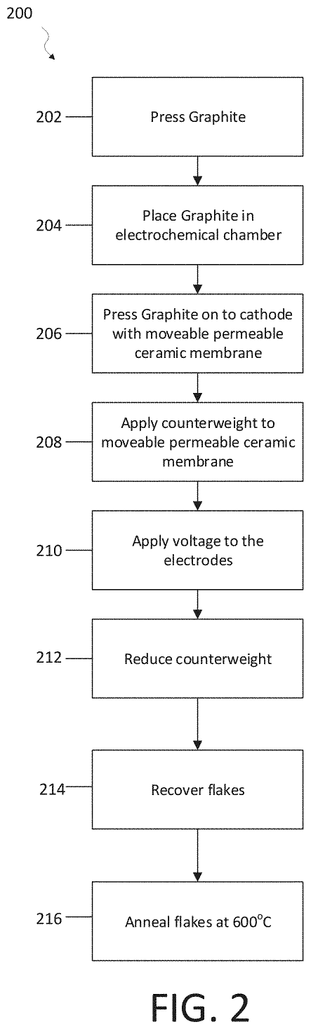

FIG. 2 is a flow chart of an example method for the expansion of graphite. At 202, graphite powder is pressed with sufficient pressure to create a graphite pellet 6, for example a pressure between 13000 and 19000 Newtons/cm². A binder is not needed to create the pellet. At 204, the graphite pellet is placed in the apparatus 1 so that it is in electrical contact with the cathode 4. At 206, the permeable ceramic membrane is pressed against the graphite pellet 6. The pressure of the ceramic membrane is used to maintain the pellet 6 in electrical contact with the cathode 4. At 208, one or more counterweights are applied to the rods 24 to maintain downward pressure on the membrane press. The counterweights result in sufficient downward pressure to maintain the graphite pellet in contact with the cathode 4, but also allow for the membrane press to be displaced upward by the expansion of graphite. The ceramic membrane can be static during operation of the apparatus, or it can move relative to the cathode during operation. For example, as the graphite pellet is exfoliated and expands, the ceramic membrane can move upward, away from the cathode, to accommodate that expansion. However, the ceramic membrane maintains sufficient downward pressure to maintain the graphite pellet in contact with the cathode, despite the expansion of graphite. At 210, a voltage is applied to the electrodes to begin exfoliation. The voltage can range from −5 to −100 V, for example −60 V. Higher voltages can increase the graphene yield.

In some implementations, fresh electrolyte is added to the reaction chamber during operation to further drive exfoliation.

In some implementations, after a period of applied voltage, the counterweight may be reduced at 212 to allow for further expansion of the graphite. Alternatively, the same counterweight can be used during the entire graphite expansion process. After adjusting the amount of counterweights, the applied voltage continues to drive exfoliation.

At 214, the resulting hydrogenated graphene flakes are recovered from the apparatus 1. At 216, the hydrogenated graphene flakes are annealed. In some implementations, the hydrogenated graphene flakes are annealed at temperatures between 100-800° C., for example between 100-300° C., between 500-800° C., or 700° C., to yield graphene. Annealing at lower temperatures requires longer exposure to heat. For example, annealing at 700° C. requires 20-30 minutes of exposure to heat. Annealing at 500° C. requires 40 minutes of exposure to heat. Annealing at 350° C. requires more than 1 hour of exposure to heat.

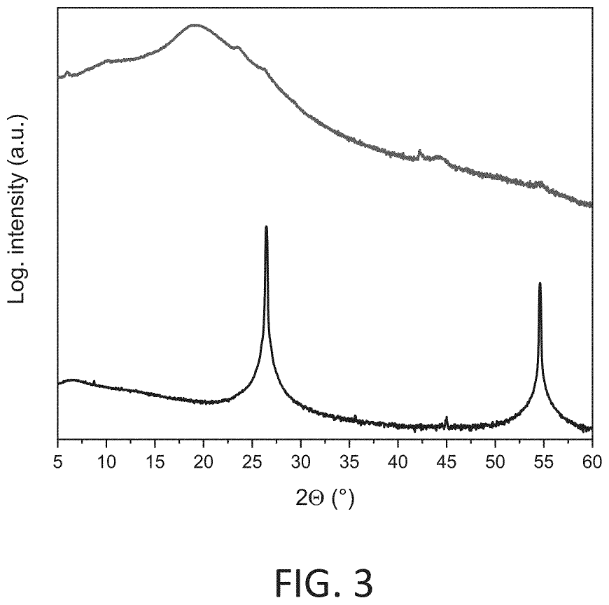

FIG. 3 is an example of an X-ray diffraction analysis of graphite and exfoliated graphite, where the intensity of the X-ray deflection is shown as a function of the diffraction angle relative to the incident beam (2Θ). Graphite (black) shows two prominent reflections at 2Θ=26.3° and 2Θ=54.4°. The peak at 2Θ=26.3° corresponds to the crystal planes of graphite with an inter-layer distance of 3.35 Å. Exfoliated graphite (red) shows that after electrochemical exfoliation the peaks at 26.3° and 54.4° largely disappear. This indicates the successful expansion of the majority of graphite. Further, the exfoliated graphite shows a broad peak at 2Θ=19.2° corresponds to an interlayer distance of 4.6 Å, which is consistent with the calculated interlayer distance of hydrogenated graphene.

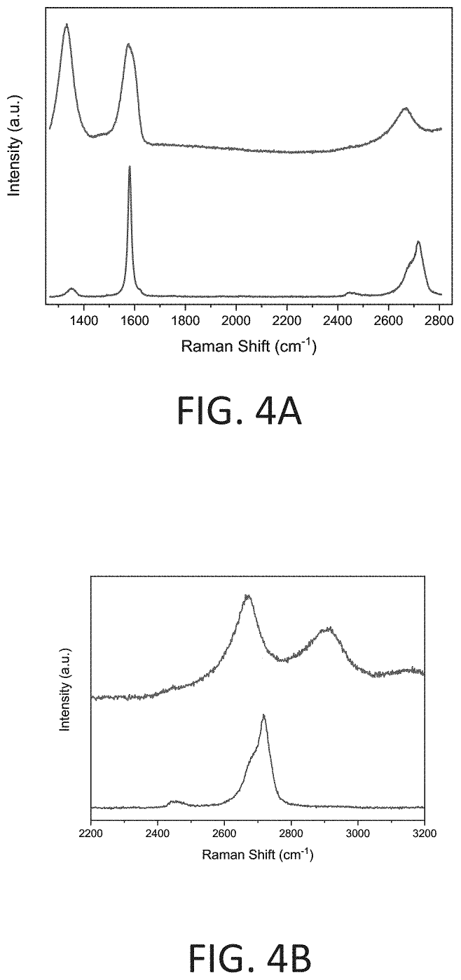

FIG. 4A and FIG. 4B are examples of Raman spectroscopy analysis of graphite before and after electrochemical treatment. Raman spectroscopy can be used as a qualitative assessment of the expansion of graphite to graphene. In particular, the “graphite” G band at 1590 cm⁻ and the “defect” D band at 1350 cm⁻ can be used as a qualitative indicators of the defect density of graphene. The G band is the result of in-plane vibrations of sp²-bonded carbon atoms. The D band originates from out-of-plane vibrations and requires a defect for its activation. Therefore, the D/G band ratio is a qualitative indicator of the material's defect density, with a smaller value indicating fewer defects. In FIG. 4A the graphite before expansion (blue) shows a prominent peak at 1590 cm⁻¹. After electrochemical treatment (red) the material shows a increased peak at 1350 cm⁻ and a prominent peak at 1590 cm⁻, suggesting that the graphite has been expanded to graphene with defects, i.e., hydrogenated graphene. Similarly, the 2D band at 2680 cm⁻ can be used as a qualitative assessment of the expansion of graphite to graphene. This band becomes asymmetric for graphene with more than 10 layers. FIG. 4B is an example Raman spectrum of graphite before (blue) and after (red) electrochemical treatment. After treatment, the 2D band at 2680 cm⁻ appears broader and flatter, and a new peak is present at approximately 2900 cm⁻, which is the D+D′ peak, further suggesting the presence of graphene with defects.

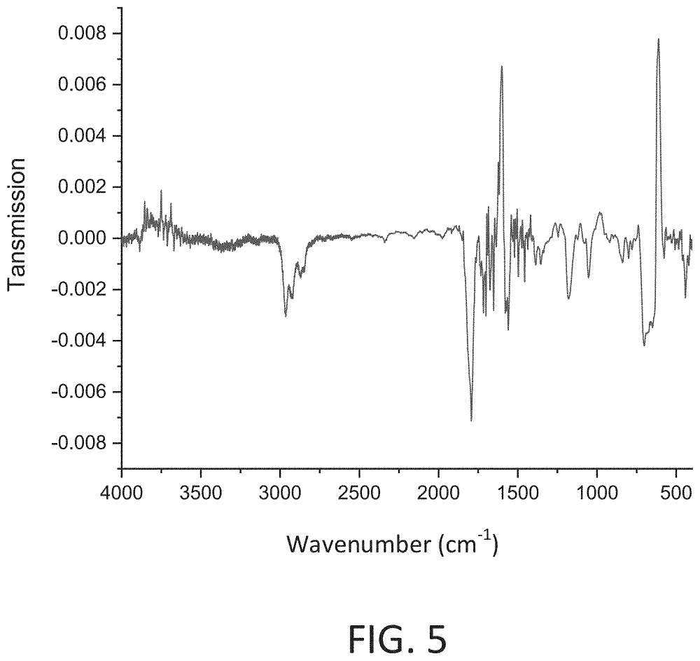

FIG. 5 is an example infrared spectroscopy analysis of graphite after electrochemical treatment. The peaks in the range of 2800 to 2900 cm⁻ are indicative of the formation of C—H bonds, suggesting that the graphite has been expanded to hydrogenated graphene. There are no C═O vibrational bands observed in the range of 1700-1750 cm⁻, suggesting that defects are not the result of oxidation.

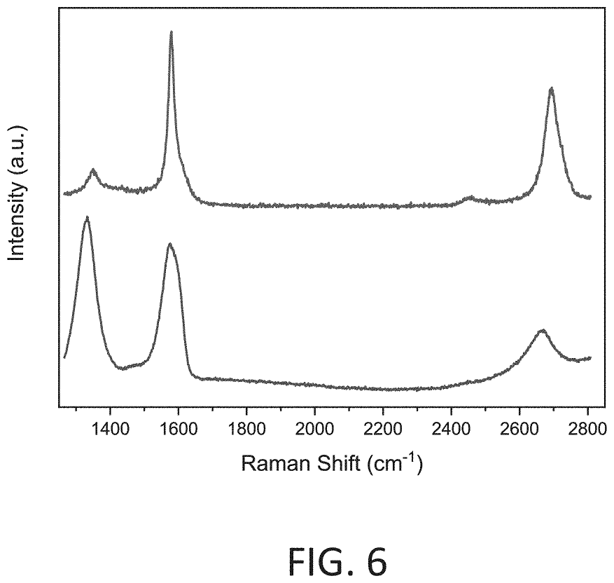

FIG. 6 is an example Raman spectroscopy analysis of the electrochemically treated graphite, i.e., hydrogenated graphene, before (blue) and after (red) annealing. The D peak at 1390 cm⁻ decreases after annealing. Since it is known that hydrogenation is reversible by annealing, the decrease in the D peak indicates that the observed defects were the result of hydrogenation.

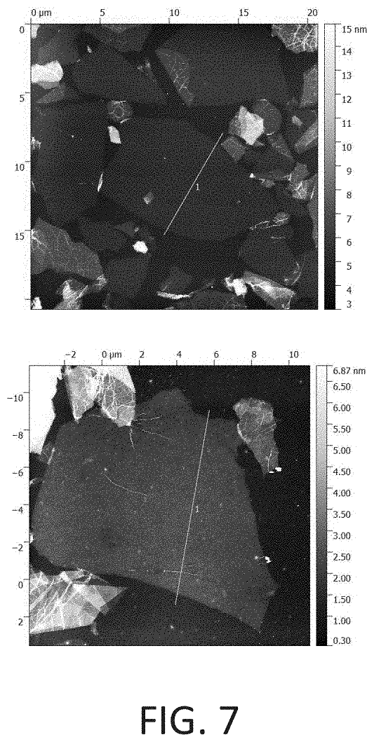

FIG. 7 is an example atomic force microscopy analysis of exfoliated flakes. The flakes assessed had diameters from around 2 μm to 15 μm, and thicknesses from around 0.8 to 2.5 nm. This analysis was performed on a SiO₂ substrate with a hydration layer between the substrate and graphene. Taking this into account, the flakes with thicknesses around 0.8 nm can be identified as single-layer graphene. Further, considering that the inter-layer distance of hydrogenated graphene is 0.46 nm, a height of 2.5 nm is consistent with four-layer graphene.

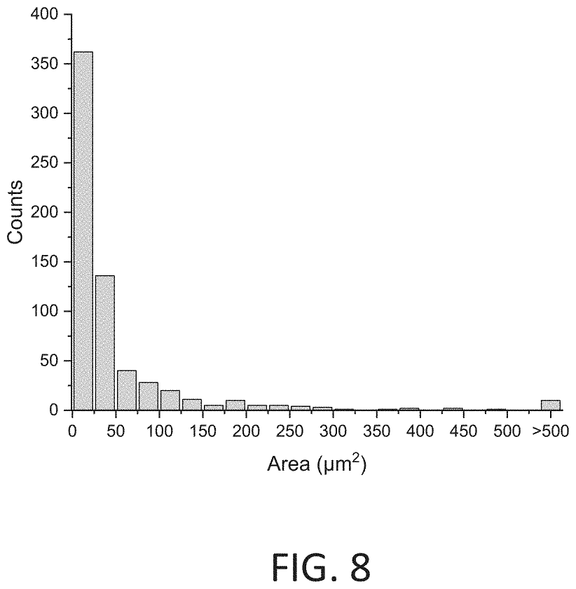

FIG. 8 is an analysis of more than 600 optical microscopy images of graphene flakes. The size distribution of these flakes is asymmetric with an average flake area of 55 μm². Flakes as large as 2000 μm² with 50 μm diameters were observed.

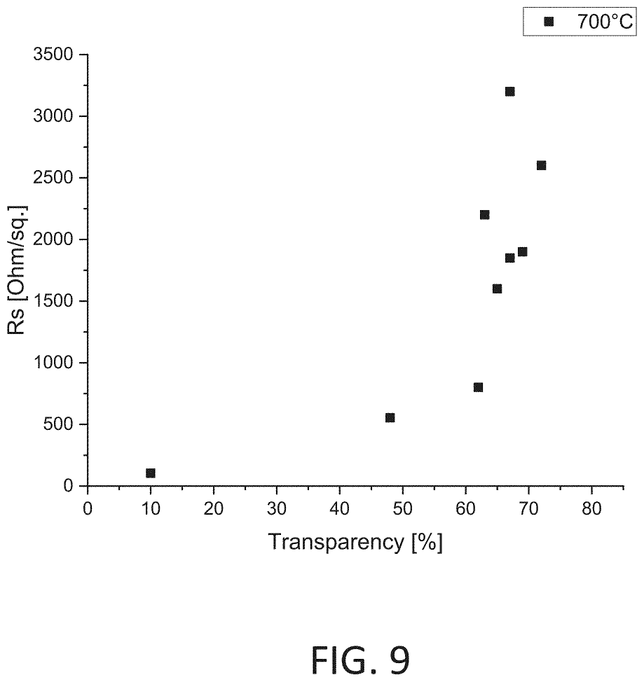

FIG. 9 is an example of an electrical conductivity analysis of annealed graphene flakes. Graphene flakes were placed as a film onto 2×2 cm² quartz glass substrates and were annealed at 700° C. to remove hydrogen. The electrical resistance was measured by the Van de Pauw method. Sheet resistance was plotted as a function of transparency at 550 nm. Films with approximately 70% transmittance at 550 nm displayed sheet resistances in the range of about 1.6 to 3.2 kΩ/cm². Less transparent films show a decrease in resistance.

What is claimed is:

1. A method for exfoliation of graphene flakes from a graphite sample, the method comprising:
compressing a graphite sample in an electrochemical reactor; and
applying a voltage between the graphite sample and an electrode in the electrochemical cell.

2. The method of claim 1, wherein compressing the graphite sample comprises:
pressing the graphite against an electrode member using a moveable ceramic membrane, wherein the ceramic membrane is permeable to the electrolyte.

3. The method of claim 1, further comprising annealing hydrogenated graphene flakes at 500 to 800° C. to yield graphene flakes.

4. The method of claim 1, wherein the electrode member is a cathode.

5. The method of claim 4, wherein the graphite sample is in electrical contact with a boron-doped diamond cathode member.

6. The method of claim 1, wherein the electrolyte comprises propylene carbonate and 0.1 M tetrabutylammonium hexafluorophosphate.

7. The method of claim 1, wherein the applied voltage is −5 V to −100 V.

8. The method of claim 1, further comprising varying a force that compresses the graphite sample.

9. The method of claim 8, wherein varying the force comprises reducing a pressure pressing the graphite sample against the cathode member after 2-3 hours of applied voltage at −60 V.

10. The method of claim 1, further comprising pelletizing the graphite sample.

11. The method of claim 1, wherein the voltage is applied for a total of 24 hours.

12. An apparatus for the exfoliation of graphite, the apparatus comprising:
an electrochemical reactor;
electrodes comprising
an anode;
a cathode member;
a graphite sample; and
a compression apparatus configured to compress the graphite sample during an exfoliation reaction.

13. The apparatus according to claim 12, wherein the compression apparatus is configured to press the graphite sample against an electrode.

14. The apparatus according to claim 13, wherein the electrode is the cathode member.

15. The apparatus according to claim 12, wherein the graphite sample is free from binder.

16. The apparatus according to claim 12, further comprising at least two anodes.

17. The apparatus according to claim 14, wherein the cathode member comprises boron-doped diamond.

18. The apparatus according to any one of claim 14, wherein the cathode member comprises a metal film.

19. The apparatus according to claim 12, wherein the apparatus further comprises an electrolyte solution.

20. The apparatus according to claim 19, wherein the electrolyte solution comprises anhydrous propylene carbonate.

21. The apparatus according to claim 19, wherein the electrolyte solution further comprises 0.1 M tetrabutylammonium hexafluorophosphate.

22. The apparatus of any one of claim 12, wherein the compression apparatus comprises:
a ceramic membrane.

23. The apparatus of claim 22, wherein:
the ceramic membrane is disposed in a membrane press; and
the membrane press comprises
one or more rods, and
one or more force application mechanisms configured to apply force to the rods.
